(19) United States
(12) Patent Application Publication
(10) Pub. No.: US 2016/0026442 A1
(43) Pub. Date: Jan. 28, 2016

(54) METHOD AND SYSTEM FOR HOSTING AND RUNNING USER CONFIGURED DYNAMIC APPLICATIONS THROUGH A SOFTWARE CONTAINER ON A COMPUTING DEVICE

(71) Applicant: MAHESH KUMAR CHHAPARIA, HYDERABAD (IN)

(72) Inventor: MAHESH KUMAR CHHAPARIA, HYDERABAD (IN)

(21) Appl. No.: 14/480,742

(22) Filed: Sep. 9, 2014

(30) Foreign Application Priority Data
Jul. 25, 2014 (IN) 3631/CHE/2014

(51) Int. Cl. G06F 9/45; G06F 21/31

(52) U.S. Cl. CPC G06F 8/41; G06F 21/31

(57) ABSTRACT

The embodiments herein provide a method and system for hosting and running user configured dynamic applications through a software container on a computing device. The system comprises a first program component for embedding a program interpreter along with a program logic for running a dynamic application; a second program component for processing the user interactions with the dynamic applications; a third program component for interacting with several computing device capabilities to provide an interface between the dynamic applications and several computing device capabilities; and a rendering engine program for rendering the dynamic applications. The first program component is an application interpreter while the second program component is a user interactions handler and the third program component is a device-bridge. The software container automatically pools and displays a specific data from the added dynamic applications to the user based on the user request.

### CROSS REFERENCE TO RELATED APPLICATIONS

This patent application claims the priority of the Indian Provisional Patent Application No, 3631/CHE/2014 filed on Jul. 25, 2014, having the title “Method and System for Hosting and Running User Configured Dynamic Applications Through a Software Container on a Computing Device”, and the content of which is incorporated herein by reference in its entirely.

### BACKGROUND

1. Technical Field

The embodiments herein generally related to mobile applications and particularly related to a dynamic binding of mobile applications and associated data on a mobile computing device. The embodiments herein more particularly relate to a method and system for hosting and running user configured dynamic applications through a software container on a mobile computing device.

2. Description of the Related Art

With the development and popularity of powerful mobile devices, there has been an increased interest in developing mobile applications that allow for the dynamic presentation and modification of data structures stored in remote data stores. Because of the challenges in data access, coding and deployment, it is difficult to quickly develop applications that dynamically bind and present data from remote data stores on mobile devices.

With respect to the creation of mobile phone applications, existing solutions in the art provide limited capabilities to address the practical hurdles encountered in their design, updating, and deployment. Various application development solutions provide the ability to create a mobile phone application that can be ported to multiple platforms or to create and run the application once on a plurality of mobile phone devices. However some application development solutions require the use of specific development languages and tools.

To avoid designing and maintaining multiple versions of the same mobile application, application developers attempted to use Extensive Markup Language (“XML”) and metadata to design one instance of a mobile application that is compatible with multiple operating platforms. However, designing mobile applications using XML and metadata is very much limited because these mobile applications often lack flexibility and customization.

Hence, there is need to provide a method and system for hosting and running user configured dynamic applications on a computing device. Also there is a need to provide a software container for hosting and running user configured dynamic applications on a computing device. There is also need to provide a method and system for fetching, storing and updating dynamic application files from a cloud server automatically, when a user requires the dynamic applications.

The above mentioned shortcomings, disadvantages and problems are addressed herein and which will be understood by reading and studying the following specification.

### OBJECTIVES OF THE EMBODIMENTS

The primary object of the embodiments herein is to provide a method and system for hosting and running user configured dynamic applications on a computing device.

Another object of the embodiments herein is to provide a software container for hosting and running user configured dynamic applications on a computing device.

Yet another object of the embodiments herein is to provide a method and system for fetching, storing and updating dynamic application files from a cloud server automatically, when a user requires the dynamic applications.

Yet another object of the embodiments herein is to provide a method for developing a dynamic application comprising a set of instructions written in an interpreted language.

Yet another object of the embodiments herein is to provide a software container for automatically pooling a specific data from one or more added dynamic applications and displaying the pooled specific data to the user, when the user requests for the specific data.

These and other objects and advantages of the embodiments herein will become readily apparent from the following detailed description taken in conjunction with the accompanying drawings.

### SUMMARY

The embodiments herein provide a method and system for hosting and running user configured dynamic applications through a software container on a computing device. The system comprises a first program component for embedding a program interpreter along with one or more program logic for running a dynamic application and wherein the first program component is an application interpreter; a second program component for processing the user interactions with a plurality of dynamic applications and wherein the second program component is a user interactions handler; a third program component for interacting with a plurality of computing device capabilities to provide an interface between the plurality of dynamic applications and the plurality of device capabilities and wherein the third program component is a device-bridge; and a rendering engine program for rendering one or more dynamic applications.

According to one embodiment herein, the plurality of computing device capabilities comprises acquiring a data from a plurality of sensors and a data stored in the computing device after acquiring user permission. The plurality of sensors comprises a GPS sensor, a temperature sensor, light sensor and a camera device. Further, the data stored in the computing device comprises user contacts, user photo library and messages.

According to one embodiment herein, the software container fetches, stores and updates the dynamic application files from a cloud server automatically, when the user requires the dynamic applications.

According to one embodiment herein, the user interactions handler allows the user to input data by any one of a click, a touch, and tap operations or through a plurality of input devices. The plurality of input devices is any one of the external input devices selected from a group consisting of a stylus pen, and a remote controller. The user interactions handler passes the user inputs to the application interpreter.

According to one embodiment herein, the computing device is selected from a group consisting of smart phones, notebook computers, desktop computers, televisions, watches, and vehicle infotainment displays.

According to one embodiment herein, the dynamic application is a set of instructions written in an interpreted language selected from the group comprising Python and JavaScript. The interpreted language is a programming language for which the application interpreter runs the language statements directly without previously compiling a program into machine language instructions. The application interpreter executes the program directly by translating each statement into a sequence of one or more subroutines already available as compiled machine language instructions.

According to one embodiment herein, the software container stores a local list, of dynamic applications added by the user. The software container updates the local list of dynamic applications when the user adds a new dynamic application or removes an existing dynamic application.

According to one embodiment herein, the software container enables the user to interact with the plurality of dynamic applications by loading the plurality of dynamic applications simultaneously for processing the plurality of dynamic applications in parallel.

According to one embodiment herein, the software container automatically loads the frequently used dynamic applications. The frequently used dynamic applications are estimated by the user based on a past history of usage, when the software container is launched by the user on the computing device.

According to one embodiment herein, the software container periodically synchronizes the latest set of added dynamic applications, latest data in the software container storage for the dynamic applications and latest running state of each of the dynamic application across a plurality of devices configured by the user. The software container automatically adds a dynamic application, when the computing device configured to receive the data, does not have the dynamic application explicitly added by the user earlier.

According to one embodiment herein, the software container automatically pools a specific data from one or more added dynamic applications and displays the pooled specific data to the user, when the user requests for the specific data.

According to one embodiment herein, the software container periodically runs the dynamic applications inside the software container to allow the dynamic applications to execute the periodic tasks. The periodic tasks include fetching one or more messages or notifications from one or more application servers. The software container provides the dynamic applications with one or more user preferences to allow the dynamic applications to customize the messages or notifications based on the predefined rules.

According to one embodiment herein, the software container comprises a Personal Identification number (PIN) to authorize users. The software container interface is locked with a PIN to prevent a user data from being visible to or accessed by the unauthorized users.

According to one embodiment herein, the software container provides Application Programme interface (API)s to receive a request from a source dynamic application for collecting a data from a target dynamic application added in the software container. The software container hands over the request only to the target dynamic application. The software container starts the target dynamic application and hands over the request, when the target dynamic application is not running. The target application fetches the requested data from a server and replies back with the requested data, when the requested data is not available with the target dynamic application.

According to one embodiment herein, a computer implemented method for hosting and running user configured dynamic applications through a software container on a computing device is provided. The method comprises a set of instructions for executing the following steps. One or more computing devices are configured for installing a software container by the user. A program interpreter is embedded along with one or more program logics for running one or more dynamic applications in the software container through an application interpreter. A user interactions handler is provided for processing the user interactions with a plurality of dynamic applications. An interface is provided between the plurality of dynamic applications and the plurality of computing device capabilities through a device-bridge. One or more dynamic applications is rendered through a rendering engine. The program files written in an interpreted language are fetched for the plurality of dynamic applications. The fetched program files are executed in the software container.

According to one embodiment herein, the method for hosting and running the user configured dynamic applications through a software container on a computing device further comprises allowing a user to add or remove one or more dynamic applications in the software container. The software container automatically adds a dynamic application, when the computing device configured to receive a data for the dynamic application does not have the dynamic application explicitly added by the user earlier. A local list of dynamic applications stored in the software container is updated after adding or removing one or more dynamic applications in the software container. The latest set of added dynamic applications, the latest data in the software container storage for the dynamic applications and the latest running state of each of the dynamic applications across a plurality of devices configured by the user are periodically synchronized. The user is allowed to interact with the plurality of dynamic applications by loading the plurality of dynamic applications simultaneously for processing the plurality of dynamic applications in parallel. The frequently used dynamic applications are loaded automatically. The frequently used dynamic applications are estimated by the user based on the past history of usage. A specific data is automatically pooled from the one or more added dynamic applications and the pooled specific data is displayed to the user, when the user requests for the specific data. The dynamic applications are periodically run inside the software container to allow the dynamic applications to execute periodic tasks. The periodic tasks include fetching one or more messages or notifications from one or more application servers. The software container provides the dynamic applications with one or more user preferences to allow the dynamic applications to customize the messages or notifications based on predefined rules. The Application Programming Interface (API)s are provided to receive a request from a source dynamic application for collecting a data from a target dynamic application added in the software container. The software container hands over the request only to the target dynamic application. The software container starts the target dynamic application and hands over the request, when the target dynamic application is not running. The target application fetches the requested data from a server and replies back with the requested data, when the requested data is not available with the target dynamic application.

According to one embodiment herein, the method for hosting and running user configured dynamic applications through a software container on a computing device further comprises receiving the user information from the user; encrypting the user information; storing the encrypted user information in a local storage; and downloading the encrypted user information from the local storage, when the dynamic application requires user authentication. The user information is stored in a private storage of the local storage. The encrypted user information is decrypted for authenticating the user.

According to one embodiment herein, the method for hosting and running user configured dynamic applications through a software container on a computing device further comprises receiving and automatically adding dynamic applications that are setup and configured by a domain administrator of an enterprise domain to which the user is associated with, based on the stored user information.

According to one embodiment herein, the dynamic application is a set of instructions written in an interpreted language selected from the group comprising Python and Javascript. The interpreted language is a programming language for which the application interpreters run the language statements directly without previously compiling a program into machine language instructions. The application interpreter executes the program directly, by translating each statement into a sequence of one or more subroutines already available as compiled machine language instructions.

According to one embodiment herein, the method for hosting and running user configured dynamic applications through a software container on a computing device further comprises locking the software container with a Personal Identification Number (PIN) to prevent the user data from being visible to or accessed by unauthorized users.

These and other aspects of the embodiments herein will be better appreciated and understood when considered in conjunction with the following description and the accompanying drawings. It should he understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a functional block diagram of a software container running dynamic applications, according to one embodiment herein.

FIG. 2 illustrates a functional block diagram of a software container adopted for hosting and running user configured dynamic applications on a computing device, according to one embodiment herein.

FIG. 3 illustrates a functional block diagram of a software container hosted on multiple computing devices, according to one embodiment herein.

FIG. 4 illustrates a control flow diagram explaining a method for receiving a request from a source dynamic application for collecting a data from a target dynamic application added in the software container, according to one embodiment herein.

FIG. 5 illustrates a flow chart explaining a method for hosting and running user configured dynamic applications through a software container on a computing device, according to one embodiment herein.

FIG. 6 illustrates a flow chart explaining a method for automatically pooling a specific data from one or more added dynamic applications, according to one embodiment herein.

FIG. 7 illustrates a flow chart explaining, a method for automatically pooling a specific data from one or more added dynamic applications, when the user requests for the specific data, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein provide a method and system for hosting and running user configured dynamic applications through a software container on a computing device. The system comprises a first program component for embedding a program interpreter along with one or more program logic for running a dynamic application and wherein the first program component is an application interpreter; a second program component for processing the user interactions with a plurality of dynamic applications and wherein the second program component is a user interactions handler; a third program component for interacting with a plurality of computing device capabilities to provide an interface between the plurality of dynamic applications and the plurality of device capabilities and wherein the third program component is a device-bridge; and a rendering engine program for rendering one or more dynamic applications.

According to one embodiment herein, the plurality of computing device capabilities comprises acquiring a data from a plurality of sensors and a data stored in the computing device after acquiring user permission. The plurality of sensors comprises a GPS sensor, a temperature sensor, light sensor and a camera device. Further, the data stored in the computing device comprises user contacts, user photo library and messages.

According to one embodiment herein, the software container fetches, stores and updates the dynamic application files from a cloud server automatically, when the user requires the dynamic applications.

According to one embodiment herein, the use interactions handler allows the user to input data by any one of a click, a touch, and tap operations or through a plurality of input devices. The plurality of input devices is any one of the external input devices selected from a group consisting of a stylus pen, and a remote controller. The user interactions handler passes the use inputs to the application interpreter.

According to one embodiment herein, the computing device is selected from a group consisting of smart phones, notebook computers, desktop computers, televisions, watches, and vehicle infotainment displays.

According to one embodiment herein, the dynamic application is a set of instructions written in an interpreted language selected from the group comprising Python and JavaScript. The interpreted language is a programming language for which the application interpreter runs the language statements directly without previously compiling a program into machine language instructions. The application interpreter executes the program directly by translating each statement into a sequence of one or more subroutines already available as compiled machine language instructions.

According to one embodiment herein, the software container stores a local list of dynamic applications added by the user. The software container updates the local list of dynamic applications when the user adds a new dynamic application or removes an existing dynamic application.

According to one embodiment herein, the software container enables the user to interact with the plurality of dynamic applications by loading the plurality of dynamic applications simultaneously for processing the plurality of dynamic applications in parallel.

According to one embodiment herein, the software container automatically loads the frequently used dynamic applications. The frequently used dynamic applications are estimated by the user based on a past history of usage, when the software container is launched by the user on the computing device.

According to one embodiment herein, the software container periodically synchronizes the latest set of added dynamic applications, latest data in the software container storage for the dynamic applications and latest running state of each of the dynamic application across a plurality of devices configured by the user. The software container automatically adds a dynamic application, when the computing device configured to receive the data, does not have the dynamic application explicitly added by the user earlier.

According to one embodiment herein, the software container automatically pools a specific data from one added dynamic applications and displays the pooled specific data to the user, when the user requests for the specific data.

According to one embodiment herein, the software container periodically runs the dynamic applications inside the software container to allow the dynamic applications to execute the periodic tasks. The periodic tasks include fetching one or more messages or notifications from one or more application servers. The software container provides the dynamic applications with one or more user preferences to allow the dynamic applications to customize the messages or notifications based. on the predefined rules.

According to one embodiment herein, the software container comprises a Personal identification number (PIN) to authorize users. The software container interface is locked with a PIN to prevent a user data from being visible to or accessed by the unauthorized users.

According to one embodiment herein, the software container provides Application Programme Interface (API)s to receive a request from a source dynamic application for collecting a data from a target dynamic application added in the software container. The software container hands over the request only to the target dynamic application. The software container starts the target dynamic application and hands over the request, when the target dynamic application is not running. The target application fetches the requested data from a server and replies back with the requested data, when the requested data is not available with the target dynamic application.

According to one embodiment herein, a computer implemented method for hosting and running user configured dynamic applications through a software container on a computing device is provided. The method comprises a set of instructions for executing the following steps. One or more computing devices are configured for installing a software container by the user. A program interpreter is embedded along with one or more program logics for running one or more dynamic applications in the software container through an application interpreter. A user interactions handler is provided for processing the user interactions with a plurality of dynamic applications. An interface is provided between the plurality of dynamic applications and the plurality of computing device capabilities through a device-bridge. One or more dynamic applications is rendered through a rendering engine. The program files written in an interpreted language are fetched for the plurality of dynamic applications. The fetched program files are executed in the software container.

According to one embodiment herein, the method for hosting and running the user configured dynamic applications through a software container on a computing device further comprises allowing a user to add or remove one or more dynamic applications in the software container. The software container automatically adds a dynamic application, when the computing device configured to receive a data for the dynamic application does not have the dynamic application explicitly added by the user earlier. A local list of dynamic applications stored in the software container is updated after adding or removing one or more dynamic applications in the software container. The latest set of added dynamic applications, the latest data in the software container storage for the dynamic applications and the latest running state of each of the dynamic applications across a plurality of devices configured by the user are periodically synchronized. The user is allowed to interact with the plurality of dynamic applications by loading the plurality of dynamic applications simultaneously for processing the plurality of dynamic applications in parallel. The frequently used dynamic applications are loaded automatically. The frequently used dynamic applications are estimated by the user based on the past history of usage. A specific data is automatically pooled from the one or more added dynamic applications and the pooled specific data is displayed to the user, when the user requests for the specific data. The dynamic applications are periodically run inside the software container to allow the dynamic applications to execute periodic tasks. The periodic tasks include fetching one or more messages or notifications from one or more application servers. The software container provides the dynamic applications with one or more user preferences to allow the dynamic applications to customize the messages or notifications based on predefined rules. The Application Programming Interface (API)s are provided to receive a request from a source dynamic application for collecting a data from a target dynamic application added in the software container. The software container hands over the request only to the target dynamic application. The software container starts the target dynamic application and hands over the request, when the target dynamic application is not running. The target application fetches the requested data from a server and replies back with the requested data, when the requested data is not available with the target dynamic application.

According to one embodiment herein, the method for hosting and running user configured dynamic applications through a software container on a computing device further comprises receiving the user information from the user; encrypting the user information; storing the encrypted user information in a local storage; and downloading the encrypted user information from the local storage, when the dynamic application requires user authentication. The user information is stored in a private storage of the local storage. The encrypted user information is decrypted for authenticating the user.

According to one embodiment herein, the method for hosting and running user configured dynamic applications through a software container on a computing device further comprises receiving and automatically adding dynamic applications that are setup and configured by a domain administrator of an enterprise domain to which the user is associated with, based on the stored user information.

According to one embodiment herein, the dynamic application is a set of instructions written in an interpreted language selected from the group comprising Python and Javascript. The interpreted language is a programming language for which the application interpreters run the language statements directly without previously compiling a program into machine language instructions. The application interpreter executes the program directly, by translating each statement into a sequence of one or more subroutines already available as compiled machine language instructions.

According to one embodiment herein, the method for hosting and running user configured dynamic applications through a software container on a computing device further comprises locking the software container with a Personal Identification Number (PIN) to prevent the user data from being visible to or accessed by unauthorized users.

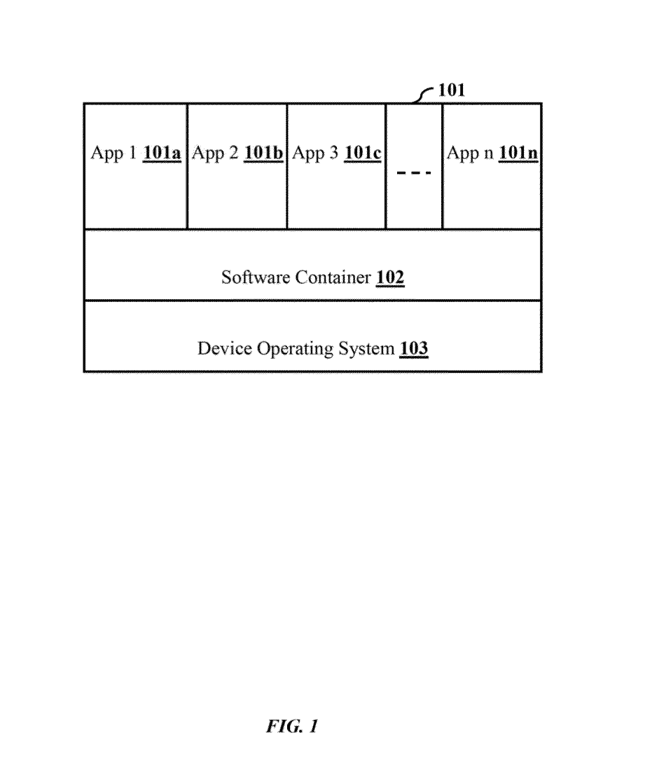

FIG. 1 illustrates a block diagram of a software container running dynamic applications, according to one embodiment herein. The embodiment herein provides a notion of dynamic applications and a software system which acts as a software container 102 to host and run dynamic applications (101a, 101b . . . 101n) through a device operating system 103 on a computing device.

According to one embodiment herein, the computing device is selected from a group consisting of smart phones, notebook computers, desktop computers, televisions, watches, and vehicle infotainment displays.

According to one embodiment herein, the dynamic application (101a, 101b . . . 101n) is a set of instructions written in an interpreted language selected from the group comprising Python and Javascript. The interpreted language is a programming language for which the application interpreters run the language statements directly, without previously compiling a program into machine language instructions. The application interpreter executes the program directly, translating each statement into a sequence of one or more subroutines already available as compiled machine language instructions.

According to one embodiment herein, the software container 102 stores a local list of dynamic applications (101a, 101b . . . 101n) added by the user. The software container updates the local list of dynamic applications (101a, 101b . . . 101n) when the user adds a new dynamic application or removes an existing dynamic application,

According to one embodiment herein, the software container 102 further comprises a search box for enabling the user to search for one or more dynamic applications listed in the local list of dynamic applications (101a, 101b . . . 101n).

According to one embodiment herein, the software container displays all the added applications in a home screen to the user. Further, the user is allowed to tap multiple applications simultaneously to load them all in parallel.

According to one embodiment herein, the software container automatically adds a new application and then syncs all the added applications in the home screen, if the device configured to receive the above data, does not have the application added explicitly. Similarly, if the device configured to receive the above data, is not owned by the user, then the software container syncs securely. The security checks comprise permission prompt on the source device from where the sync data is being pulled from, or a username and password that the user owning the source device may have set for this data.

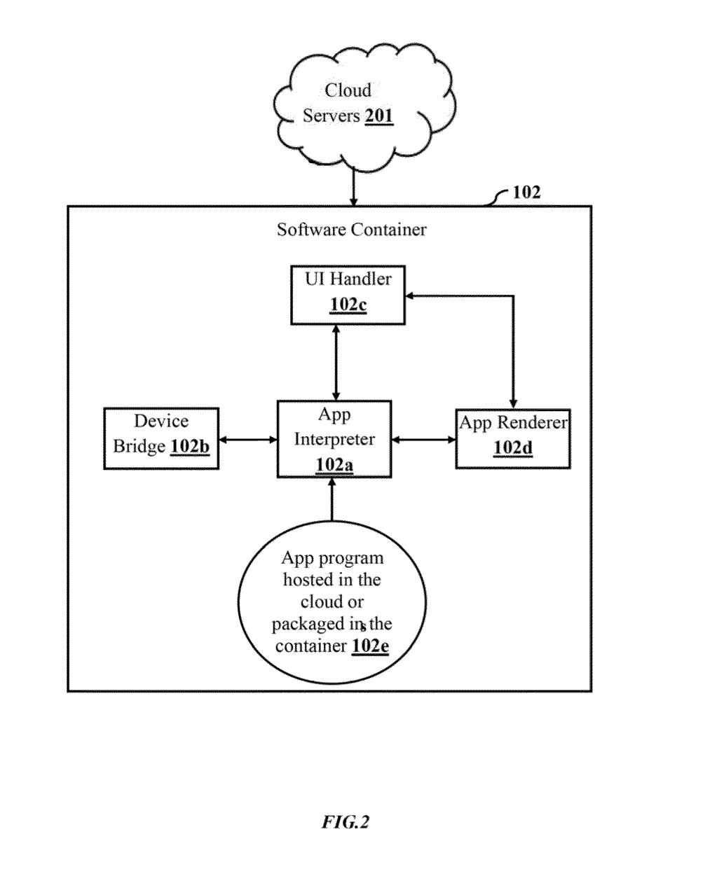

FIG. 2 illustrates a block diagram of a software container adopted for hosting and running user configured dynamic applications on a computing, device, according to one embodiment herein. The software container 102 comprises an application interpreter 102a as a first program component for embedding a program interpreter along with one or more program logic for running a dynamic application; a user interactions handler 102c as a second program component for processing user interactions with plurality of dynamic applications; a device-bridge 102b as a third program component for interacting with a plurality of computing device capabilities to provide an interface between a plurality of dynamic applications and the plurality of device capabilities; and a rendering engine program (application renderer) 102d for rendering one or more dynamic applications.

According to one embodiment herein, the program is split into plurality of computer files, such as but not limited to images, text files, configuration files, and properties files. The raw program along with dependent assets for a dynamic application is hosted on the cloud servers 201 or on the third party servers or packaged within the software container 102e.

According to one embodiment herein, the plurality of computing device capabilities comprises acquiring a data from a plurality of sensors and a data stored in the computing device after acquiring user permission. The plurality of sensors comprises a GPS sensor, a temperature sensor, light sensor and a camera device. Further, the data stored in the computing device comprises user contacts, user photo library and messages.

According one embodiment herein, the software container 102 fetches, stores and updates dynamic application files from a cloud server automatically, when the user requires the dynamic applications.

According to one embodiment herein, the user interactions handler 102c allows the user to input data by any one of a click, a touch, and tap operations or through a plurality of input devices. The plurality of input devices is any one of the external input devices selected from a group consisting of a stylus pen, and a remote controller. The user interactions handler 102c passes the user inputs to the application interpreter 102a.

According to one embodiment herein, the software container 102 enables the user to interact with the plurality of dynamic applications by loading the plurality of dynamic applications simultaneously for processing the plurality of dynamic applications in parallel.

According to one embodiment herein, the software container 102 automatically loads frequently used dynamic applications. The frequently used dynamic applications are estimated by the user based on the past history of usage, when the software container 102 is launched by the user on the computing device.

According to one embodiment herein, the software container 102 periodically syncs latest set of added dynamic applications, latest data in the software container storage for the dynamic applications and latest running state of each of the dynamic application across a plurality of devices configured by the user. The software container 102 automatically adds a dynamic application, when the computing device configured to receive the said data, does not have the dynamic application explicitly added by the user earlier.

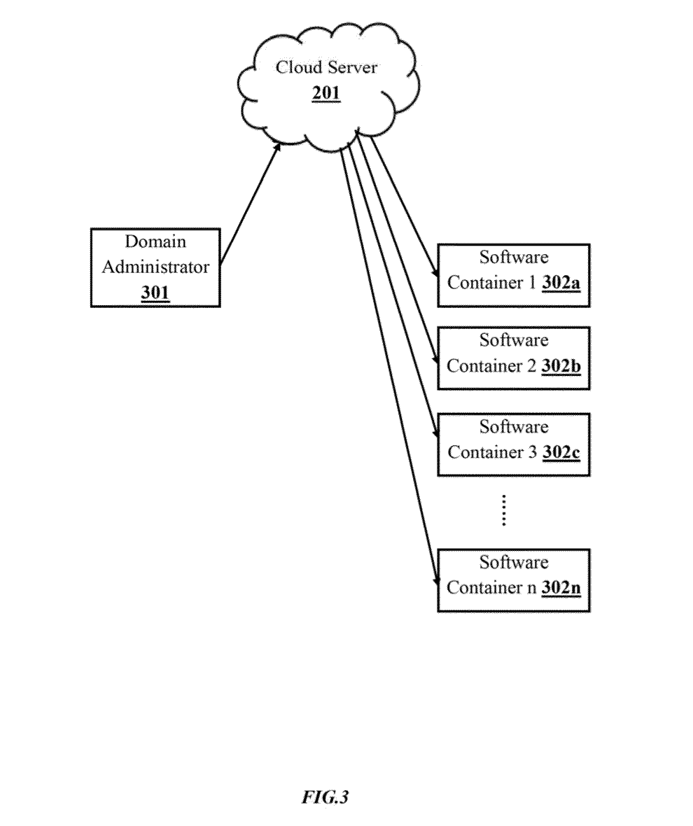

FIG. 3 illustrates a block diagram of a software container hosted on multiple computing devices, according to one embodiment herein. Plurality of software containers (302a, 302b, 302c . . . 302n) are hosted on multiple computimy, devices as shown in FIG. 3. The plurality of software containers (302a, 302b, 302c . . . 302n) are controlled by a domain administrant 301 through a cloud server 210. Each software container automatically pools a specific data from one or more added dynamic applications and displays the pooled specific data to the user, when the user requests for the specific data. For example, the domain administrator 301 may have configured the application servers to send app files customized for each user, such as each user's username and password that could be embedded in the app program so the user doesn't need to know or remember username and password for each such app. As soon as the user would launch a company app, the username and password stored in the app by the domain administrator 301, would be automatically used by the software container to authenticate the user. Further, the software container periodically checks in the application server for new or removed apps in the group or apps added or removed for a specific user. All these changes are immediately reflected on the user computing, device after each such check.

According to one embodiment herein, the software container periodically runs dynamic applications inside the software container to allow the dynamic applications to execute periodic tasks. The periodic tasks include retching one or more messages or notifications front one or more application servers. The software container provides dynamic applications with one or more user preferences to allow the dynamic applications to customize the messages or notifications based on predefined rules.

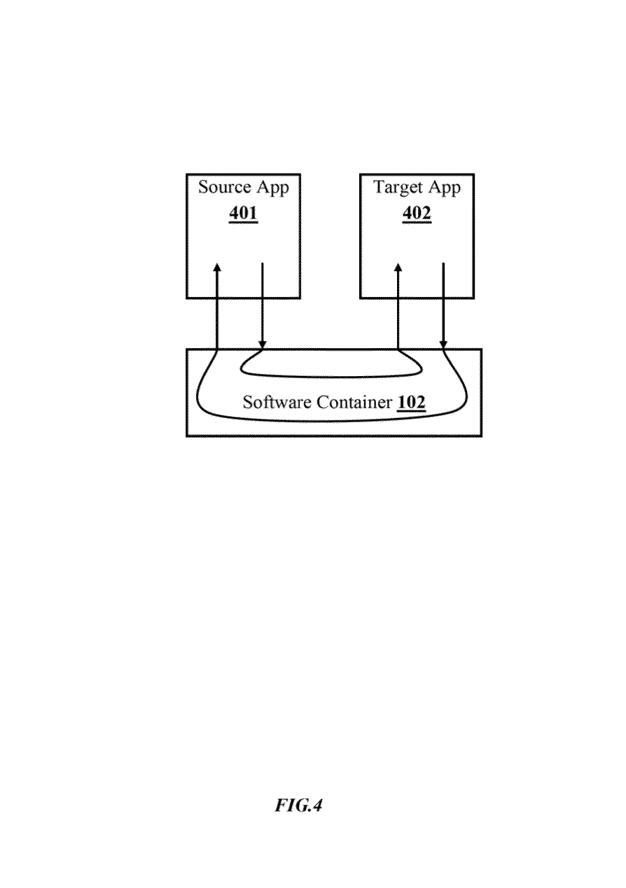

FIG. 4 illustrates a control flow diagram indicating a method for receiving a request from a source dynamic application for collecting a data from a target dynamic application added in the software container, according to one embodiment herein. The software container 102 provides APIs to receive a request from a source dynamic application 401 for collecting a data from a target dynamic application 402 added in the software container 102. The software container 102 hands over the request only to the target dynamic application 402. The software container 102 starts the target dynamic application 402 and hands over the request, when the target dynamic application 402 is not running. The target application 402 fetches the requested data from a server and replies back with the requested data, when the requested data is not available with the target dynamic application 402.

According to one embodiment herein, the software container comprises a PIN to authorize users. The software container interface is locked with a PIN to prevent user data from being visible to unauthorized users.

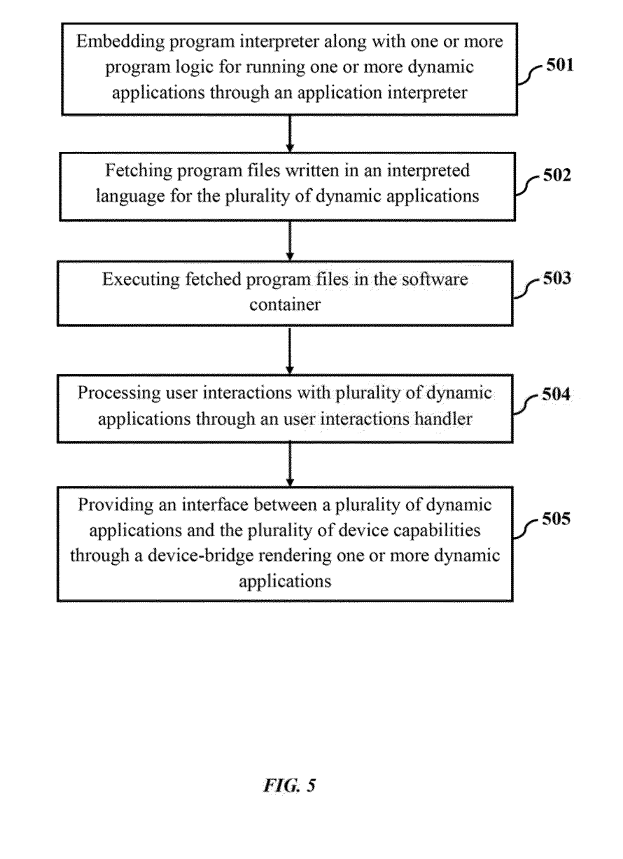

FIG. 5 illustrates a flow chart explaining a method for hosting and running user configured dynamic applications through a software container on a computing device, according to one embodiment herein. The method comprises the steps of configuring one or more computing devices for installing a software container by the user; embedding program interpreter along with one or more program logic for running one or more dynamic applications through an application. interpreter (501); fetching program files written in an interpreted language for the plurality of dynamic applications (502); executing fetched program files in the software container (503); processing user interactions with plurality of dynamic applications through an use interactions handler (503); and providing an interface between a plurality of dynamic applications and the plurality of device capabilities through a device-bridge rendering one or more dynamic applications (504).

According to one embodiment herein, the method for hosting and naming user configured dynamic applications through a software container on a computing device further comprises: allowing a user to add or remove one or more dynamic applications in the software. container, and the software container automatically adds a dynamic application, when the computing device configured. to receive a data for the dynamic application does not have the dynamic application explicitly added by the user earlier; updating a local list of dynamic applications stored in the software container after adding or removing one or more dynamic applications in the software container; periodically synchronizing latest set of added dynamic applications, latest data in the software container storage for the dynamic applications and latest running state of each of the dynamic applications across a plurality of devices configured by the user; allowing the user to interact with the plurality of dynamic applications by loading the plurality of dynamic applications simultaneously for processing the plurality of dynamic applications in parallel; automatically loading frequently used dynamic applications and wherein the frequently used dynamic applications are estimated by the user based on the past history of usage; automatically pooling a specific data from or more added dynamic applications and displaying the pooled specific data to the user, when the user requests for the specific data; periodically running the dynamic applications inside the software container to allow the dynamic applications to execute periodic tasks and the periodic tasks include fetching One or more messages or notifications from one or more application servers, and the software container provides dynamic applications with one or more user preferences to allow the dynamic applications to customize the messages or notifications based on predefined rules; and providing APIs to receive a request from a source dynamic application for collecting a data from a target dynamic application added in the software container, and the software container hands over the request only to the target dynamic application, and the software container starts the target dynamic application and hands over the request, when the target dynamic application is not running, and the target application fetches the requested data from a server and replies back with the requested data, when the requested data is not available with the target dynamic application.

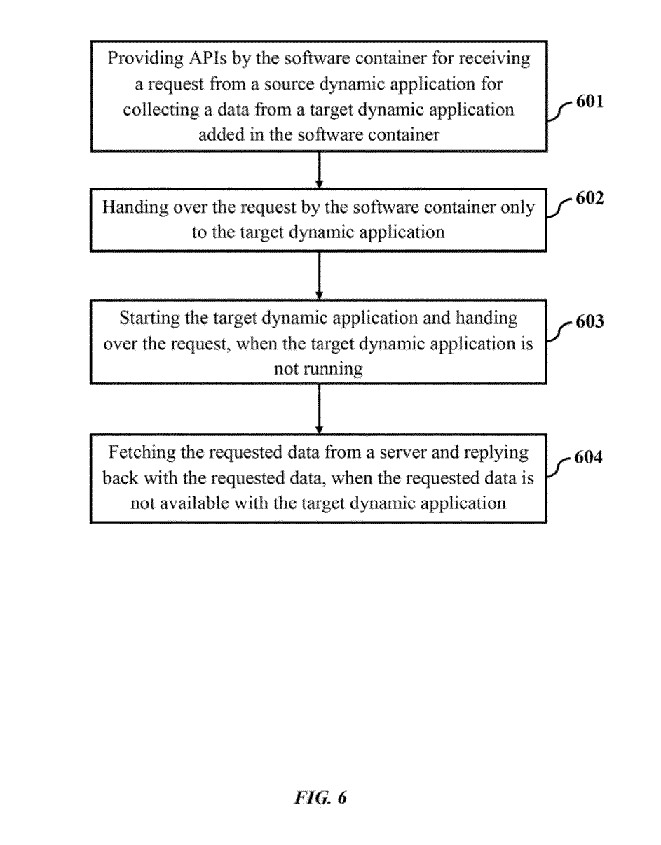

FIG. 6 illustrates a flow chart explaining a method for automatically pooling a specific data from one or more added dynamic applications, according to one embodiment herein. The method comprises steps of: providing APIs by the software container for receiving a request from a source dynamic application for collecting a data from a target dynamic application, added in the software container (601); handing over the request by the software container only to the target dynamic application (602); starting the target dynamic application and handing over the request, when the target dynamic application is not running (603); and fetching the requested data from a server and replying back with the requested data, when the requested data is not available with the target dynamic application (604).

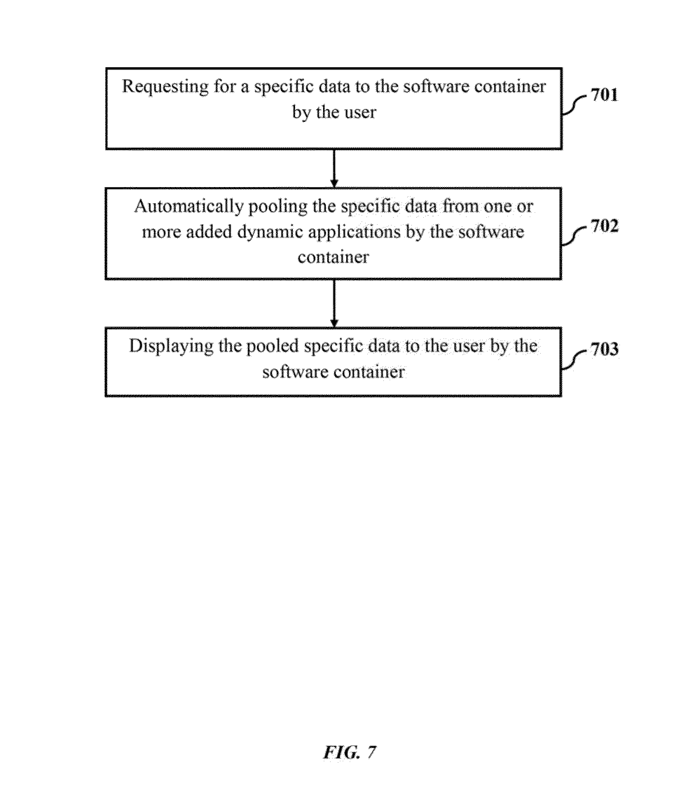

FIG. 7 illustrates a flow chart explaining a method for automatically pooling a specific data from one or more added dynamic applications, when the user requests for the specific data, according to one embodiment herein. The method comprises steps of: requesting for a specific data to the software container by the user (701); automatically pooling the specific data from one or more added dynamic applications by the software container (702); and displaying the pooled specific data to the user by the software container (703). According to one embodiment herein, the software container itself pulls a data from a target dynamic application even without requiring a request from a source dynamic application.

According to one embodiment herein, the method for hosting and running user configured dynamic applications through a software container on a computing device further comprises receiving the user information from the user; encrypting the user information; storing the encrypted user information in a local storage, and the user information is stored in a private storage of the local storage; and downloading the encrypted user information from the local storage, when the dynamic application requires user authentication, and wherein the encrypted user information is decrypted for authenticating the user.

According to one embodiment herein, the method for hosting and running user configured dynamic applications through a software container on a computing device further comprises receiving and automatically adding dynamic applications that are setup and configured by a domain administrator of an enterprise domain to which the user is associated with, based on the stored user information.

According to one embodiment herein, the dynamic application is a set of instructions written in an interpreted language selected from the group comprising Python and JavaScript. The interpreted language is a programming language for which the application interpreters run the language statements directly, without previously compiling a program into machine language instructions, and the application interpreter executes the program directly, translating each statement into a sequence of one or more subroutines already available as compiled machine language instructions.

According to one embodiment herein, the method for hosting and running user configured dynamic applications through a software container on a computing device further comprises locking the software container with a PIN to prevent user data from being visible to unauthorized users.

The various embodiments herein provide a method and system for hosting and running user configured dynamic applications on a computing device. The embodiments herein provide, a software container for hosting and running user configured dynamic applications on a computing device.

The embodiments herein provides a method and system for fetching, storing and updating dynamic application files from a cloud server automatically, when a user requires the dynamic applications. The dynamic application is a program written in an interpreted language such as Python or Javascript. The interpreted language is a programming language for which most of its execution engines (called interpreters) run the language statements directly, without previously compiling a program into machine language instructions. The interpreter executes the program directly, translating each statement into a sequence of one or more subroutines already available as compiled machine language instructions.

The software container of the embodiments herein automatically pools a specific data from one or more added dynamic applications and displays the pooled specific data to the user, when the user requests for the specific data.

The software container reduces the latency of getting the updated application to a user to almost an imperceptible duration. If a small change is made to the app by a developer, the change can be visible near instantly to the users the developer chooses to the push the change to, without having to download an entirely new binary on each target user device. This reduces the latency to use the updated app, to a very small duration which in most cases would be imperceptible to the user unlike the latency observed with present day mechanisms of installing and interacting with mobile applications, where the user almost certainly waits for at least several seconds to several minutes.

The software container automatically recommends applications relevant for the user, when the user is traveling or based on the applications the user has used so far and the history of usage. To achieve this, the software container runs a machine learning algorithm using this data and the index of all applications designed to run within this software container, and come up with the list of relevant applications.

The software container allows the user to use recommended applications without the need for a download of a binary for each such application, thereby reducing the user latency significantly.

The software container further knows exactly the need or requirement of the user for a certain or specific application while using the device and can open the required specific application directly or straightaway thereby eliminating the need for the user to search for the certain or specific application on the device.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A system for hosting and running user configured dynamic applications through a software container on a computing device, the system comprises:
a first program component for embedding a program interpreter along with one or more program logic for running a dynamic application, and wherein the first program component is an application interpreter;
a second program component for processing, user interactions with a plurality of dynamic applications, and wherein the second program component is a user interactions handler; and
a third program component for interacting with a plurality of computing device capabilities to provide an interface between a plurality of dynamic applications and the plurality of device capabilities, and wherein the third program component is a device-bridge; and
a rendering engine program for rendering one or more dynamic applications.

2. The system according to claim 1, wherein the plurality of Computing device capabilities comprises acquiring a data from a plurality of sensors and a data stored in the computing device after acquiring a user permission, and wherein the plurality of sensors comprises a GPS sensor, a temperature sensor, light sensor and a camera device and wherein the data stored in the computing device comprises user contacts, user photo library and messages.

3. The system according to claim 1, wherein the software container fetches, stores and updates dynamic application files from a cloud server automatically, when the user requires the dynamic applications.

4. The system according to claim 1, wherein the user interactions handler allows the user to input data by any one of a click, a touch, and a tap operations or through a plurality of input devices, and wherein the plurality of input devices is any one of the external input devices selected from a group consisting of a stylus pen, a remote controller, and a keyboard, and wherein the user interactions handler passes the user inputs to the application interpreter.

5. The system according to claim 1, Wherein the computing device is selected from the group consisting of smart phones, notebook computers, desktop computers, televisions, watches, and vehicle infotainment displays.

6. The system according to claim 1, wherein the dynamic application is a set of instructions written in an interpreted language selected from the group comprising Python and Javascript, and wherein the interpreted language is a program ling language for which the application interpreters run the language statements directly, without previously compiling a program into machine language instructions, and wherein the application interpreter executes the program directly, translating each statement into a sequence of one or more subroutines already available as compiled machine language instructions.

7. The system according to claim 1, wherein the software container stores a local list of dynamic applications added by the user, and wherein the software container updates the local list of dynamic applications when the user adds a new dynamic application or removes an existing dynamic application.

8. The system according to claim 1, wherein the software container enables the user to interact with the plurality of dynamic applications by loading the plurality of dynamic applications simultaneously for processing the plurality of dynamic applications in parallel.

9. The system according to claim 1, wherein the software container automatically loads frequently used dynamic applications and wherein the frequently used dynamic applications are estimated based on the past history of the usage and the user information, when the software container is launched by the user on the computing device.

10. The system according to claim 1, wherein the software container periodically syncs latest set of added dynamic applications, latest data in the software container storage for the dynamic applications and latest running state of each of the dynamic application across a plurality of devices configured by the user, and wherein the software container automatically adds a dynamic application, when the computing device configured to receive the said data, does not have the dynamic application explicitly added by the user earlier.

11. The system according to claim 1, wherein the software container automatically pools a specific data from one or more added dynamic applications and displays the pooled specific data to the user, when the user requests for the specific data.

12. The system according to claim 1, wherein the software container periodically runs dynamic applications inside the software container to allow the dynamic applications to execute periodic tasks and wherein the periodic tasks include fetching one or more messages or notifications from one or more application servers, and wherein the software container provides dynamic applications with one or more user preferences to allow the dynamic applications to customize the messages or notifications based on predefined rules.

13. The system according to claim 1, wherein the software container comprises a PIN to authorize users, and wherein the software container interface is locked with a PIN to prevent user data from being visible to unauthorized users.

14. The system according to claim 1, wherein the software container provides APIs to receive a request from a source dynamic application for collecting a data from a target dynamic application added in the software container, and wherein the software container hands over the request only to the target dynamic application, and wherein the software container starts the target dynamic application and hands over the request, when the target dynamic application is not running, and wherein the target application fetches the requested data from a server and replies back with the requested data, when the requested data is not available with the target dynamic application.

15. A computer implemented method for hosting and running user configured dynamic applications through a software container on a computing device, the method comprises a. set of instructions for:
configuring one or more computing devices for installing a software container by the user;
embedding a program interpreter along with one or more program logics for running one or more dynamic applications in the software container through an application interpreter;
providing a user interactions handler for processing user interactions with a plurality of dynamic applications;
providing an interface between the plurality of dynamic applications and the plurality of computing device capabilities through a device-bridge;
rendering one or more dynamic applications;
fetching program files written in an interpreted language for the plurality of dynamic applications; and
executing fetched program files in the software container.

16. The method according to claim 15, wherein the method further comprises:
allowing a user to add or remove one or more dynamic applications in the software container, and wherein the software container automatically adds a dynamic application, when the computing device configured to receive a data for the dynamic application does not have the dynamic application explicitly added by the user earlier;
updating a local list of dynamic applications stored in the software container after adding or removing one or more dynamic applications in the software container;
periodically synchronizing latest set of added dynamic applications, latest data in the software container storage for the dynamic applications and latest running state of each of the dynamic applications across a plurality of devices configured by the user;
allowing the user to interact with the plurality of dynamic applications by loading the plurality of dynamic applications simultaneously for processing the plurality of dynamic applications parallel;
automatically loading frequently used dynamic applications and wherein the frequently used dynamic applications are estimated based on the past history of usage and user information;
automatically pooling a specific data from one or more added dynamic applications and displaying the pooled specific data to the user, when the user requests for the specific data;
periodically running the dynamic applications inside the software container to allow the dynamic applications to execute periodic tasks and wherein the periodic tasks include fetching one or more messages or notifications from one or more application servers, and wherein the software container provides dynamic applications with one or more user preferences to allow the dynamic applications to customize the messages or notifications based on predefined rules; and
providing APIs to receive a request from a source dynamic application for collecting a data from a target dynamic application added in the software container, and wherein the software container hands over the request only to the target dynamic application, and wherein the software container starts the target dynamic application and hands over the request, when the target dynamic application is not running, and wherein the target application fetches the requested data from a server and replies back with the requested data, when the requested data is not available with the target dynamic application.

17. The method according to claim 15 further comprises:
receiving the user information from the user;
encrypting the user information;
storing the encrypted user information in a local storage, and wherein user information is stored in a private storage of the local storage; and
downloading the encrypted user information from the local storage, when the dynamic application requires user authentication, and wherein the encrypted user information is decrypted for authenticating the user.

18. The method according: to claim 15 further comprises the step of receiving and automatically adding dynamic applications that are setup and configured by a domain administrator of an enterprise domain to which the user is associated with, based on the stored user information.

19. The method according to claim 15, wherein the dynamic application is a set of instructions written in an interpreted language selected from the group comprising Python and Javascript, and wherein the interpreted language is a programming language for which the application interpreters run the language statements directly, without previously compiling a program into machine language instructions, and wherein the application interpreter executes the program directly, translating each statement into a sequence of one or more subroutines already available as compiled machine language instructions.

20. The method according to claim 15 further comprises locking the software container with a PIN to prevent user data from being visible to unauthorized users.
